(19) United States
(12) Patent Application Publication
(10) Pub. No.: US 2013/0346155 A1
(43) Pub. Date: Dec. 26, 2013

(54) SYSTEMS AND METHODS FOR COLLECTING AND ANALYZING REAL-TIME CUSTOMER FEEDBACK

(71) Applicant: Humm Systems, LLC, Austin, TX (US)

(72) Inventor: Bernard Edwin Briggs, Austin, TX (US)

(21) Appl. No.: 13/928,321

(22) Filed: Jun. 26, 2013

Related U.S. Application Data
(60) Provisional application No. 61/690,367, filed on Jun. 26, 2012.

(51) Int. Cl. G06Q 30/02

(52) U.S. Cl. CPC G06Q 30/0203
USPC 705/7.32

(57) ABSTRACT

A system and method for digitally collecting and analyzing real-time customer feedback. In at least one embodiment, a tablet computer or other digital device is used to collect guest feedback on-site in real time. The device sends the feedback to a server where the feedback is stored and analyzed. The feedback can then be viewed from a Client Portal, which can also be used to customize and configure the Device in real-time.

### CROSS-REFERENCE TO RELATED APPLICATIONS

This application claims priority to U.S. Provisional Application Ser. No. 61/690,367 filed Jun. 26, 2012, which is hereby incorporated by reference.

### FIELD OF THE INVENTION

The invention relates to systems and methods to collect and analyze customer feedback.

### BACKGROUND OF THE INVENTION

Customer feedback is useful content for product and service marketers and has been collected in various ways, such as survey options printed on sales receipts, online ratings and reviews, and direct customer contact via phone, mail, electronic mail, or in person.

Customer feedback management services have been developed for online and offline use to allow businesses to manage user suggestions and complaints in a structured fashion. Studies indicate that companies managing customer feedback have a better customer retention rate. The aim of most methodologies is to measure customer satisfaction and customer loyalty through. These methodologies are commonly implemented in web-based applications as web-based tools. Some methodologies use email surveys, which tend to be cumbersome and available long after the guest experience, which allows the guest to put it off, possibly never responding, or responding with a delay. Some methodologies use comment cards which are also cumbersome and are generally not trusted. Some methodologies use phone surveys which often occur long after the guest experience and are easy for the guest to avoid or disengage. Some methodologies use receipt invites, which require the guest to notice the invitation on the receipt and take the initiative to participate, and make the effort to go to a website an enter their unique code or similar situations. Existing methodologies are cumbersome and result in very low participation rates and lack authentic feedback.

With low participation rates, businesses do not receive accurate analytics. Many times only extreme cases will be reported. Also, with some services, for example comment cards typically found in restaurants, businesses themselves, or third party services, would have to go through each customer's feedback and organize the information, which takes time and effort before being able to analyze the information, plus the business would be delayed in responding to the feedback.

Furthermore, many of the customer feedback services solicit customer opinions in a delayed setting. Customers may fill out surveys or reviews after leaving the business. With such a delay, the customer's opinions and recollections may be skewed, or enhanced, and details may be forgotten. With a delay, business owners cannot be sure they are receiving accurate information about a customer's real experience.

The approaches described in this section could be pursued, but are not necessarily approaches that have been previously conceived or pursued. Therefore, unless otherwise indicated herein, the approaches described in this section are not prior art to the claims in this application and are not admitted to be prior art by inclusion in this section.

### BRIEF SUMMARY OF THE INVENTION

The disclosed subject matter relates to systems and methods to collect and analyze customer feedback. Generally a method is provided for sending pre-selected customization data to a digital device located in a consumer setting, receiving consumer setting feedback related to a guest's experiences with the consumer setting from the digital device, and sending results related to the consumer setting feedback to a private client portal.

In some embodiment the consumer setting is a restroom, a bar, an event, a concert, an airport, or a combination of these, etc.

In some embodiments the customization data includes prompts, questions, advertisements, promotions, surveys, themes, a combination of these, etc.

In some embodiments, the guest is a paying customer, a non-paying customer, a member, an attendee, a visitor, a shopper, a patron, a combination of these, etc.

In some embodiments, the client portal is controlled by an authority of the consumer setting, for example, a manager, an owner, a director, an officer, a combination of these, etc.

In some embodiments, the results include at least a portion of the consumer setting feedback and an analysis based on the consumer setting feedback.

In some embodiments, the analysis includes assessing feedback trends.

In some embodiments, the analysis includes assessing a sentiment of the feedback.

In some embodiments the sentiment of the feedback includes positive, negative, neutral, a combination of these, etc.

Some embodiments include the step of storing the consumer setting feedback on a computer readable medium.

In some embodiments the customization data is configured via the client portal.

In some embodiments, the client portal is accessed via a client computer.

Some embodiments include receiving alert configurations for alert in response to a predetermined feedback event.

In some embodiments, the client portal is accessed via the Internet.

In some embodiments the digital device is a portable tablet computer.

Some embodiments include receiving device health information from the digital device, and sending the device health information to the client portal.

Some embodiments teach a system for collecting feedback. The system includes a digital device, a client portal, a server with an interface, a memory, and a processor. The steps of sending pre-selected customization data to a digital device located in a consumer setting, receiving consumer setting feedback related to a guest's experiences with the consumer setting from the digital device, and sending results related to the consumer setting feedback to a private client portal are performed on the processor.

In some embodiments the digital device is a tablet computer.

In some embodiments a check presenter houses said portable digital device.

Some embodiments teach the method of receiving preselected consumer setting customization data in a consumer setting, receiving consumer setting feedback associated with a guest related to the guest's experience associated with the consumer setting, and sending the consumer setting feedback to a private client portal.

These and other aspects of the disclosed subject matter, as well as additional novel features, will be apparent from the description provided herein. The intent of this summary is not to be a comprehensive description of the subject matter, but rather to provide a short overview of some of the subject matter's functionality. Other systems, methods, features and advantages here provided will become apparent to one with skill in the art upon examination of the following FIGURES and detailed description. It is intended that all such additional systems, methods, features and advantages that are included within this description, be within the scope of any claims filed later.

### BRIEF DESCRIPTIONS OF THE DRAWINGS

The novel features believed characteristic of the disclosed subject matter will be set forth in the claims. The disclosed subject matter itself, however, as well as a preferred mode of use, further objectives, and advantages thereof, will best be understood by reference to the following detailed description of illustrative embodiments when read in conjunction with the accompanying drawings, wherein:

FIG. 1 depicts a diagram of one embodiment of the system.

FIG. 2 depicts a flow chart of one embodiment of the method.

FIG. 3 depicts a screenshot of a Dashboard of one embodiment of the Client Portal.

FIG. 4 depicts a screenshot of Guest Sessions in one embodiment of the Client Portal.

FIG. 5 depicts a screenshot of Guest Comments in one embodiment of the Client Portal.

FIG. 6 depicts a screenshot of Guest Email in one embodiment of the Client Portal.

FIG. 7 depicts a screenshot of Guest Sessions Details in one embodiment of the Client Portal.

FIG. 8 depicts a screenshot of Sentiment trends in one embodiment of the Client Portal.

FIG. 9 depicts a screenshot of Participation trends in one embodiment of the Client Portal.

FIG. 10 depicts a screenshot of Device Health in one embodiment of the Client Portal.

FIG. 11 depicts a screenshot of the General Account Settings in one embodiment of the Client Portal.

FIG. 12 depicts a screenshot of User Account Settings in one embodiment of the Client Portal.

FIG. 13 depicts a screenshot of Promotions Setup Settings in one embodiment of the Client Portal.

FIG. 14 depicts a screenshot of a Weekly Insights Report in one embodiment of the Client Portal.

In the FIGURES, like elements should be understood to represent like elements, even though reference labels are omitted on some instances of a repeated element, for simplicity.

### DETAILED DESCRIPTION OF ILLUSTRATIVE EMBODIMENTS

Reference now should be made to the drawings, in which the same reference numbers are used throughout the different figures to designate the same components.

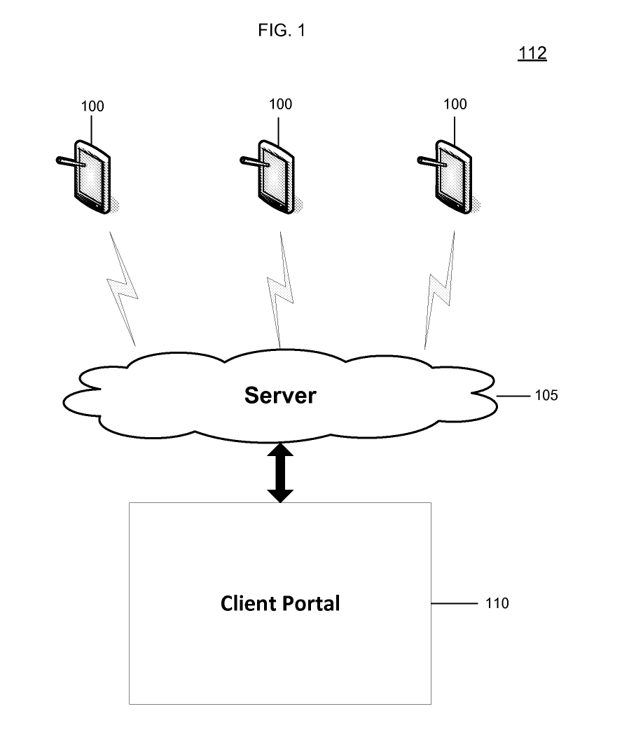

FIG. 1 depicts a diagram of one embodiment of the system 112. A Device 100 collects feedback, which is analyzed and stored on a Server 105 accessible through a Client Portal 110.

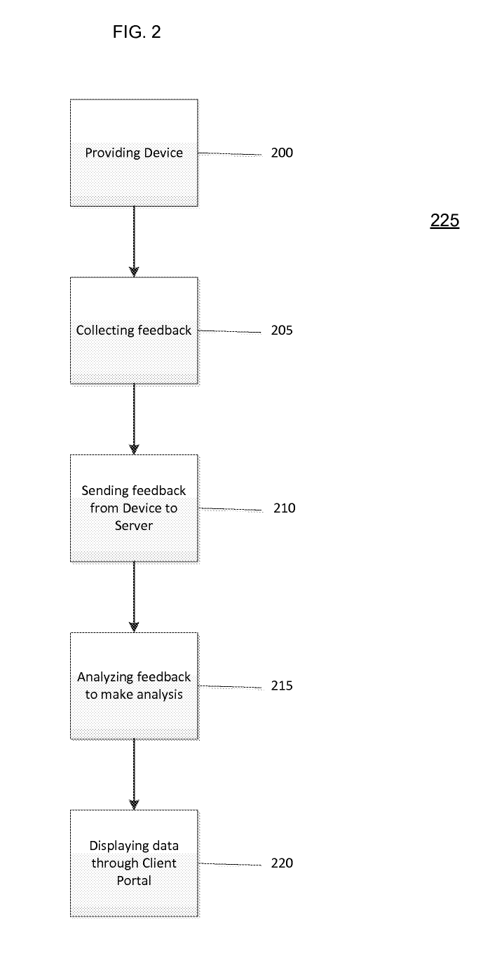

FIG. 2 depicts a flow chart of one embodiment of the method 225. In a first step 200 the Device 100 is provided to a Guest. A Guest is anyone that provides feedback, for example a paying customer, a non-paying customer, a sampler, a visitor, etc. The Guest does not have to purchase, experience or use offered goods or services to provide feedback or be considered a Guest.

In step 205, Guest feedback is collected from Device 100. The system may use multiple Devices 100. In one embodiment, the Device 100 may be configurable in real-time from a Client Portal 110. In this disclosure, real-time means without delay, the information moves as quickly as the network or wired connection moves data without appreciable transport lag. In another embodiment, the Device 100 may be configurable on the Device 100 itself. The Device 100 may work on or off of a wireless or wired network. The feedback is queued on the Device 100 if a network is unavailable and the feedback is uploaded to the Server 105 when the network becomes available. The Device 100 may be configured to send the feedback data in real time or at any time frequency, for example at a set time each day, or a set interval, for example every two hours, etc. In some embodiments, the Device 100 has the capability to be assigned to data property, value, people, tables, etc. The Device 100 may collect email and other contact information from the Guest and associate that contact information with the Guest's feedback to allow for follow up, sending promotions, etc. The Device 100 may be configured for any language and may offer language selection options to the Guest. The Device 100 may be stored in, on, or otherwise connected to a check presenter, or other item used to present a check, bill or receipt to a Guest. In some embodiments, the Device 100 may comprise a soft case guest check presenter, a soft case guest check presenter that has a top cover and bottom cover hinged together along a common binding to define a booklet and uses an ambient light sensor in the digital device to automatically turn the display on or off when the software case is open or closed respectively with or without inside pocket, a hard case guest check presenter, a kiosk, a standalone kiosk, a wall mounted kiosk, a personal digital assistant, a portable computer, a tablet computer, a tablet computer locked in a USB charging station as if in a kiosk, etc. In one embodiment, the Device 100 has a theft deterrence system that authorizes the Device's 100 use based on physical location and invokes a device recovery system that tracks the location. In another embodiment, the Device 100 may display promotions during, before, or after the feedback session with the client user. In some embodiments, the Device 100 may display the Guest's check, bill, receipt etc., allow the Guest to pay via the Device 100, and/or allow the Device 100 to email the Guest's receipt to the Guest's email address.

Feedback may be in the form of web pages, photos, images, text, audio, video, a combination thereof, etc. In one embodiment, the feedback is sent through a wireless network to the Server 105. In another embodiment, the feedback is sent through a wired network to the Server 105. In a third embodiment, the Device 100 communicates directly with the Client Portal 110. In another embodiment the Device 100 communicates via a wired connection when connected via a wired connection to either the Server 105, or the Client Portal 110, and communicates via a wireless connection to either the Server 105 or the Client Portal 110, or both when not connected via a wired connection. In some embodiments the Device 100 remains in a location, for example a table, a bar, etc., may be removably attached to the table, bar, etc. In some embodiments the Device 100 can charge while on the table, bar, etc.

In step 210, the feedback is sent from the Device 100 to the Server 105. The Server 105 may be run on a computer. The computer may be a general-purpose computer or a special-purpose computer, but generally comprises RAM, storage, and a processor. In another embodiment, the Server 105 may be a cloud server. In another embodiment, the Server 105 and the Client Portal 110 are accessed on the same computer.

In step 215, the feedback is analyzed to produce an analysis. In another embodiment, the feedback is analyzed by a third-party and stored on the Server 105. In some embodiments, some or all of the feedback is not analyzed and instead is presented in raw form.

In step 220, the feedback and/or analysis (hereinafter referred to as “data”) is displayed through a Client Portal 110. In one embodiment, the Client Portal 110 is accessible on the Internet. In another embodiment, the Client Portal 110 is accessible on software installed on a computer. In some embodiments the Client Portal 110 can be accessed using an application on a mobile computer. The Client Portal 110 is private and not accessible to the public. The Client Portal is generally only accessible by an authority of the consumer setting, and those authorized by an authority of the consumer setting. An authority of the consumer setting includes a manager of the consumer setting, an owner of the consumer setting, a director of the consumer setting, and officer of the consumer setting, a combination of these, etc.

One possible use for the system and method is in the restaurant industry. The restaurant personnel can program the Device 100 to show the restaurant's logo and to ask questions related to the specific services, atmosphere, food and drink offerings, etc. available at the restaurant. Additionally, if the restaurant is trying to improve in a certain area, for example, customer service, they can choose their questions to help gauge their progress and/or how to improve in that area, for example asking direct questions related to the waiters, how quickly the Guest's needs were met, how quickly they were seated, the disposition of the staff, etc. The restaurant can put the Device 100 in a typical check presenter, or a check presenter of their choosing. The restaurant may have enough check presenters such that every one of their tables could have one at the same time, more or fewer depending on their needs. The check presenters may be stored in a charging station or otherwise such that a waiter could pick up the check presenter including the Device 100 directly from the charger, put the check inside, and then return the check presenter including the Device 100 directly to the charger after the check has been paid so that the restaurant would not have to constantly monitor the battery life of each Device 100.

When the Guest receives their check, they will also be presented with the Device 100 requesting feedback. At this point the restaurant could also offer an incentive for providing feedback, such as a coupon, a chance to win a prize, a discount on their current check, etc. The guest has the opportunity to vent, respond, or otherwise provide feedback directly at the table immediately following the experience, allowing for more sincere and accurate feedback. The questions may be multiple choice, fill in the blank, open ended etc. The restaurant could even configure the Device 100 to request the Guest to take a photograph or video of their party, food, experience etc. with the Device 100 itself, or with their own camera or smartphone to be sent to the restaurant, so that the restaurant can use the photographs for marketing, in an online gallery, etc.

In the case that the Guest is dissatisfied with the waiter, but enjoyed the food, the restaurant's chosen questions would allow the Guest to give the waiter a low score, but give the food and atmosphere a high score. This can help the restaurant decide where to improve and how. Had the Guest waited until he/she got home, the Guest might have chosen to leave a review on a public review platform. By that point the Guest might have discussed how upsetting the waiter was with friends building his/her frustration for the experience as a whole, and the Guest's review might only talk about the waiter, or more generally just leave a review saying it was a terrible experience. Such reviews can have a negative effect on potential business without providing the restaurant with necessary information to improve the deficiencies. Since the restaurant can customize what information is sent to the Device 100, the Guest is at least partially guided in their feedback, diminishing the likelihood of a cursory review, whether good, okay, or bad feedback, that fails to give the restaurant information about distinct aspects of the experience that could help the restaurant improve.

In the case that the Guest enjoyed the atmosphere but thought the lights were a bit too dim to comfortably read the menu, the Guest might not deem such information worthy of leaving a review on a public review platform, but if the Guest is presented with the question “How was the atmosphere of the restaurant?” while he/she is still seated in the restaurant, then the Guest is more likely to let the restaurant know that it would be easier to read the menus if it was a bit brighter. By using the Device 100, the restaurant can capture valuable input from its Guests without requiring much effort from the Guests or souring their Guests by being pushy and insistent. Further, this system and method provides a business with a higher participation rate, for example, the restaurant captures more reviews by getting on-site feedback with an easy-to-use Device 100 than they would relying merely on existing review methods.

Once the Guest has finished providing feedback via the device 100 and paid their check, the waiter picks up the check presenter including the check, payment, and Device 100 and returns the check presenter to the charging station.

From the Client Portal 110, a manager of the restaurant can view in real-time the reviews and ratings and analytics related to the feedback. If a particular waiter is getting consistently good reviews, the manager can compliment or reward the waiter to increase morale and encourage the effort to continue. Alternatively, if a waiter is getting consistently poor reviews, the manager can determine what the issue is and potentially improve it before the waiter's shift is finished, rather than having an entire shift of bad reviews. Additionally, if the manager notices via the Client Portal 110 that Guests are consistently commenting that the food is overcooked, the manager can speak with the kitchen and ask the chefs to reduce the cook time a bit. Not only can the restaurant prevent the bad experiences from continuing for the entire night, but the manager can also follow the Client Portal 110 to see if the changes that are made have a positive effect on the feedback. In some instances the manager may see feedback from a table in real-time, and while the waiter is processing the payment from the Guest that left the feedback, the manager can visit the Guest's table to apologize, offer compensation, and/or request that the Guest please come back again and leave another sincere review to see if they have improved.

Since the Guests that were dissatisfied were able to vent at the table, they would be more confident that their complaints might lead to improvements, and most would not feel the need to vent again on public review platforms. Additionally, Guests who were very satisfied often feel that they owe the restaurant a kind review, and will still review on both the Device 100 and public review platforms. This combination results in meaningful feedback given immediately on-site, potential marketing through the Guest providing contact information, a photograph, or a review worth sharing, as well as positive overall ratings on public review platforms which encourages continued business for the restaurant. While the benefit to the restaurant in this example is clear, the Guests also benefit from the restaurant improving based on the feedback they provided, as well as from promotions and possible follow-up that may result from the Guests providing feedback.

While a restaurant was used in this example, the disclosed systems and methods are useful in a variety of consumer settings in a variety of industries and this disclosure intends to apply to all consumer settings and industries where feedback is valuable. In this disclosure, a consumer setting includes any setting a guest is present in, attends, visits, etc. In this disclosure, a guest is a paying consumer, a non-paying consumer, a patron of the consumer setting, a member of the consumer setting, an attendee, a visitor, a shopper, a client, a combination of these, etc. For example, the consumer setting may be a restroom, a bar, an event, a concert, a performance, an airport, a service provider, a combination of these, etc.

The figures below depict screenshots of different displays of the Client Portal 110. The information displayed through the Client Portal 110 does not have to be in the same organization, order, or on the same display as shown. Further, different feedback can be used and different analyses applied in different embodiments of this disclosure.

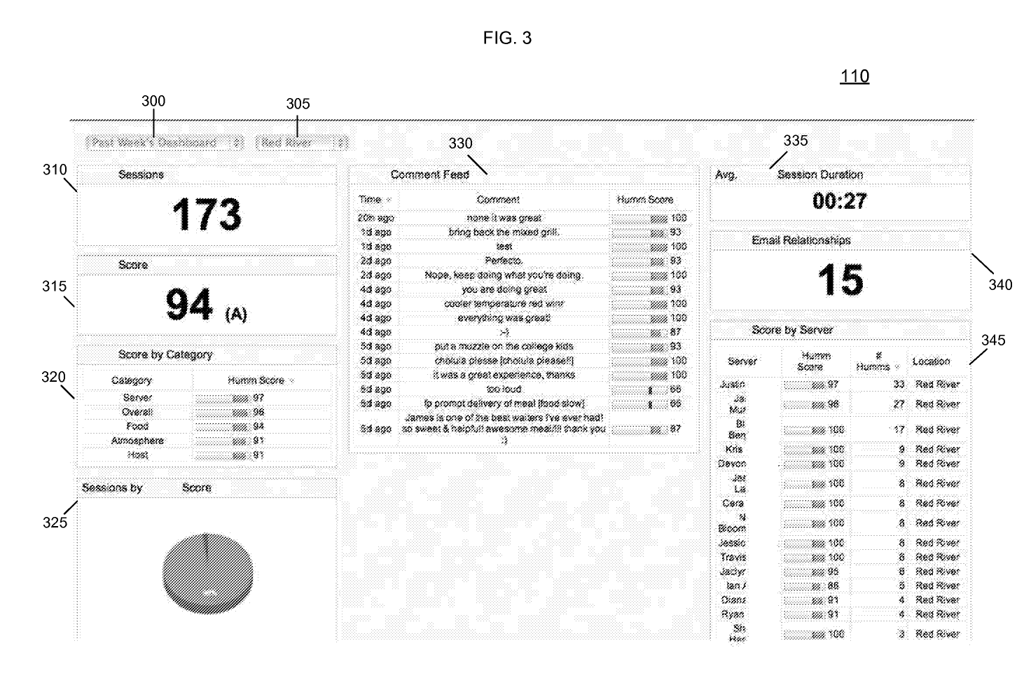

FIG. 3 depicts a screenshot of a Dashboard of one embodiment of the Client Portal 110. In one embodiment, the Client Portal 110 shows the Number of Guest Sessions 310. The Number of Guest Sessions 310 is the number of times a Guest has provided feedback. In another embodiment, a Score 315 is shown. The Score 315 is the grade the Client receives based on feedback. In some embodiments, the Score 315 may include only numeral values received by the Guest. In some embodiments, the Score 315 may include values derived from positive or negative written feedback. The Score may also be shown based on different categories 320, for example, atmosphere, food, overall, waiter, service, etc. The Score may also be shown in a graph form 325. In an embodiment, the Client Portal 110 may show a Comment Feed 330, showing, for example, the time, comment, and score of each Guest feedback. In some embodiments, the Comment Feed 330 may be updated in real time, while in other embodiments the Comment Feed 330 may be updated at set time intervals. In another embodiment, the Client Portal 110 may show an Average Session Duration 335. Also in other embodiments, the Client Portal 110 may show individual session durations, the number of Email Relationships 340, etc. Email Relationships 340 may occur when a Guest's email address is received, which in some embodiments may be required, while in other embodiments it is optional. Additionally in some embodiments the Guest can choose how the email address is to be used, for example for newsletters, follow-up, promotions, advertisements, transmittal of a receipt or bill, VIP list, etc. The Client Portal 110 may also show the Score categorized by each data property, value, person, table, etc. individual Devices 100 are assigned to 345. The Client Portal may also be configured to show information based on different time periods 300, for example, today, yesterday, last week, or last month, between two customizable dates, etc. The Client Portal may also be configured to display different locations 305.

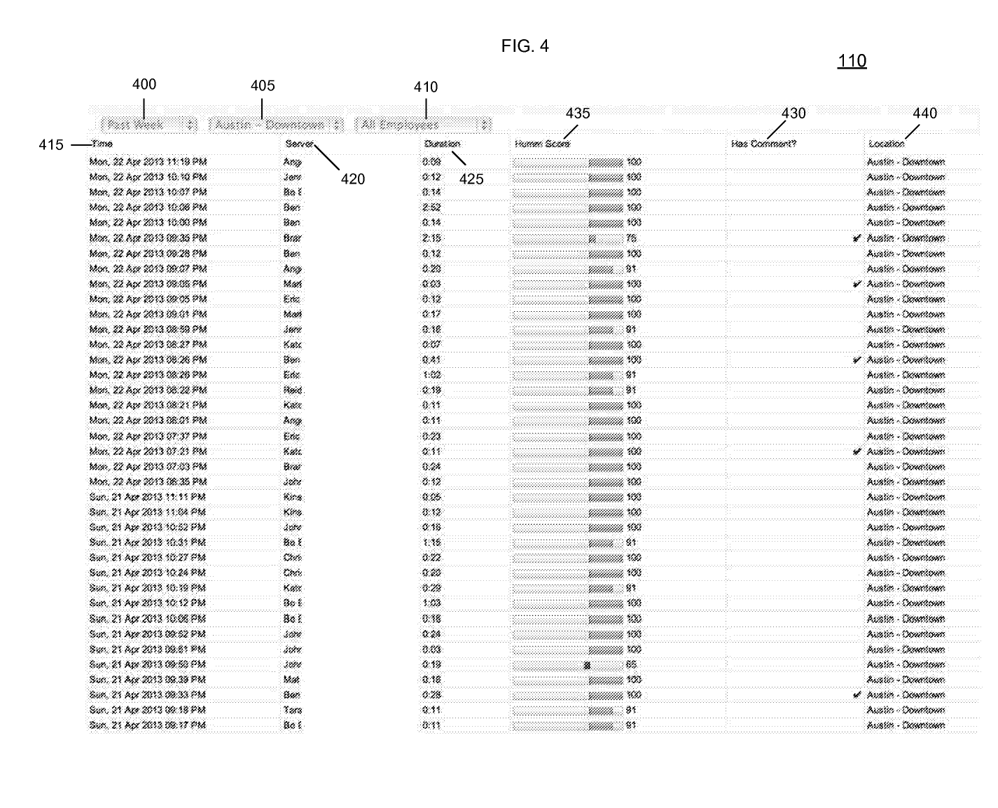

FIG. 4 depicts a screenshot of Guest Sessions in one embodiment of the Client Portal 110. The Client Portal 110 may be configured to display different locations 405, different assigned Devices 410, and different time periods 400. The Client Portal 110 may display the time that feedback was provided 415. The Client Portal 110 may also display the assigned data property, value, person, table, etc. of the Device that received the feedback 420. The Client Portal may also display the duration of each Guest Session 425. The Client Portal may also display the Score of each feedback 430 which may be a score determined by the Guest, or may be a score determined by the analysis on the feedback provided. The Client Portal 110 may show if a comment is received from a Guest 435, or in other embodiments may show the comment itself. The Client Portal 110 may further show from which location the feedback was received 440 in the case that the consumer setting has several locations, or if the consumer setting is divided into sections, for example main bar, porch bar, dining area, etc.

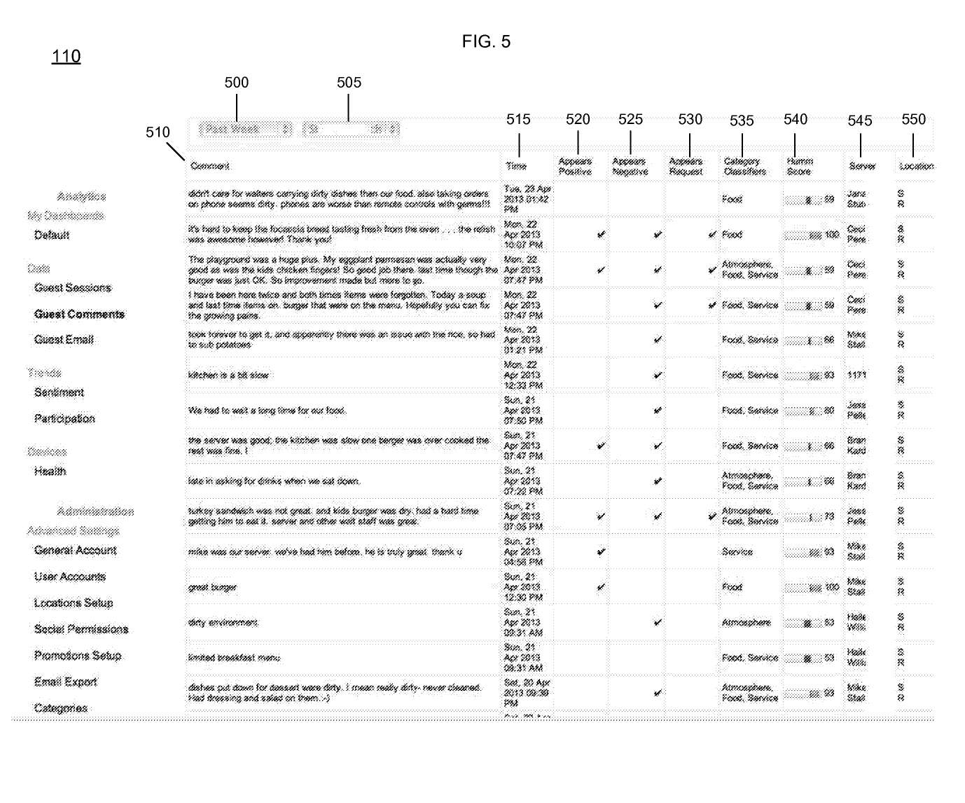

FIG. 5 depicts a screenshot of a display of Guest Comments in one embodiment of the Client Portal 110. The Client Portal 110 may be configured to display different locations 505, different assigned Devices, and different time periods of Guest Comments 500. In one embodiment, the Client Portal 110 may display the comment(s) received from a Guest 510. The Comments allow for Guests to make note of things that the Client User had not included in the configured questions and allows the Guests to be more specific with their input. The Client Portal may also display the time and date of each comment 515, or any other relevant data, for example if the Guest took a picture of their food to show that their food was burned as stated in their comment. The Client Portal may analyze and display whether the comment appears positive 520, negative 525, or if a request appears to be made by the Guest 530. For example a keyword identifier or other analysis could be used to assess the sentiment of a Guest comment, to determine if positive words are used and determine that the sentiment is positive, and represent this through a score, a code, a symbol, a letter, a number, a ranking, a graph, etc. The comment sentiment analysis allows the Client User to quickly identify, sort and address the comments based on their category or importance. The Client Portal 110 may display Category Classifiers of each comment 535. In one embodiment, the Client Portal 110 may display the Score associated with the Guest Session that included the comment 540, this score may be based on the analysis of the feedback. In another embodiment, the Client Portal 110 may also display the assigned data property, value, people, table, etc. of the Device that received the comment and feedback 545. The Client Portal may display the location that the feedback was received 550 in the case that the Client User has several locations, or if the Client User divides up their business into sections, for example main bar, porch bar, dining area, etc.

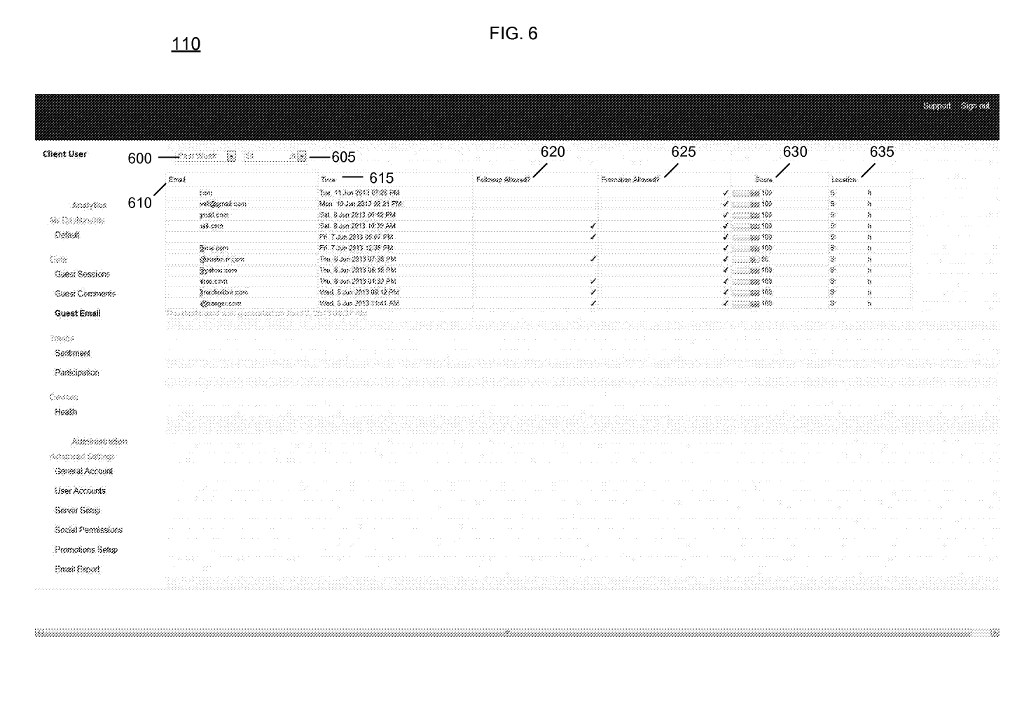

FIG. 6 depicts a screenshot of Guest Email in one embodiment of the Client Portal 110. The Client Portal 110 may be configured to display different locations 605 and different time periods 600 of email addresses received from Guests. The Client Portal may display the email address 610 received from the Guest. The Client Portal 110 may also display the date and time 615 the email address was received. In one embodiment, the Client Portal 110 may display whether the Guest has indicated they would allow follow-up correspondence 620 to the email address supplied. The Client Portal 110 may also display whether a promotion may be sent to the email address received 625. The Client Portal 110 may display the Score 630 of the feedback session associated with the email address to help the Client User identify which Guests may require more immediate follow-up. The Client Portal 110 may display the location 635 that the email address was received in the case that the Client User has several locations, or if the Client User divides up their business into sections, for example main bar, porch bar, dining area, etc. The email addresses received can be used to send promotions, follow up, invitations, etc.

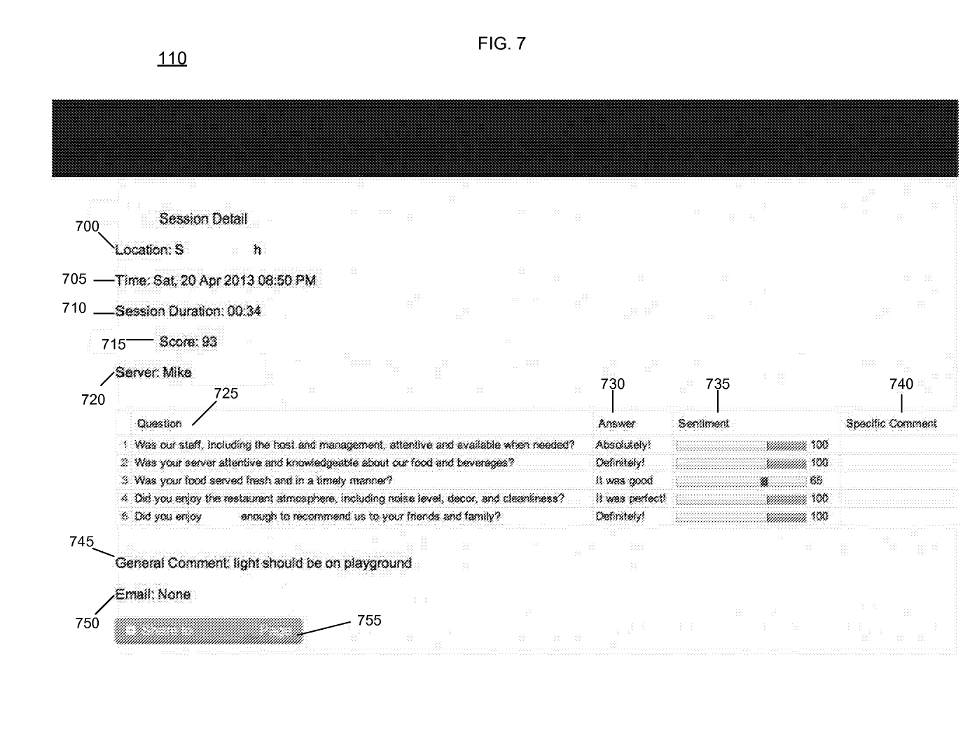

FIG. 7 depicts a screenshot of Guest Sessions Details in one embodiment of the Client Portal 110. The Guest Sessions Details display may show the location 700, time and date 705, session duration 710, and score 715 of the Guest Session. The Client Portal 110 may also display the assigned data property or value or people of the Device that received the feedback 720. In one embodiment, the Client Portal 110 may display the question(s) 725 and answer(s) 730 from the Guest Session. The Client Portal may also display the associated Sentiment Score 735 of each Answer. The sentiment score may represent an analysis of how positive or negative some or all of the feedback is, for example a keyword identifier or other analysis could be used to assess the sentiment of a Guest comment. The Client Portal 110 may display the category associated with the answer as well as specific comments 740 received in the session. The Client Portal 110 may also display a General Comment 745 received by the Guest. The Client Portal may also display an email address 750 received from the Guest. In one embodiment, the Client Portal may provide a link to share the Guest Session Details with the public 755. This could be via social networking websites, the Client User's website, public review platforms, etc.

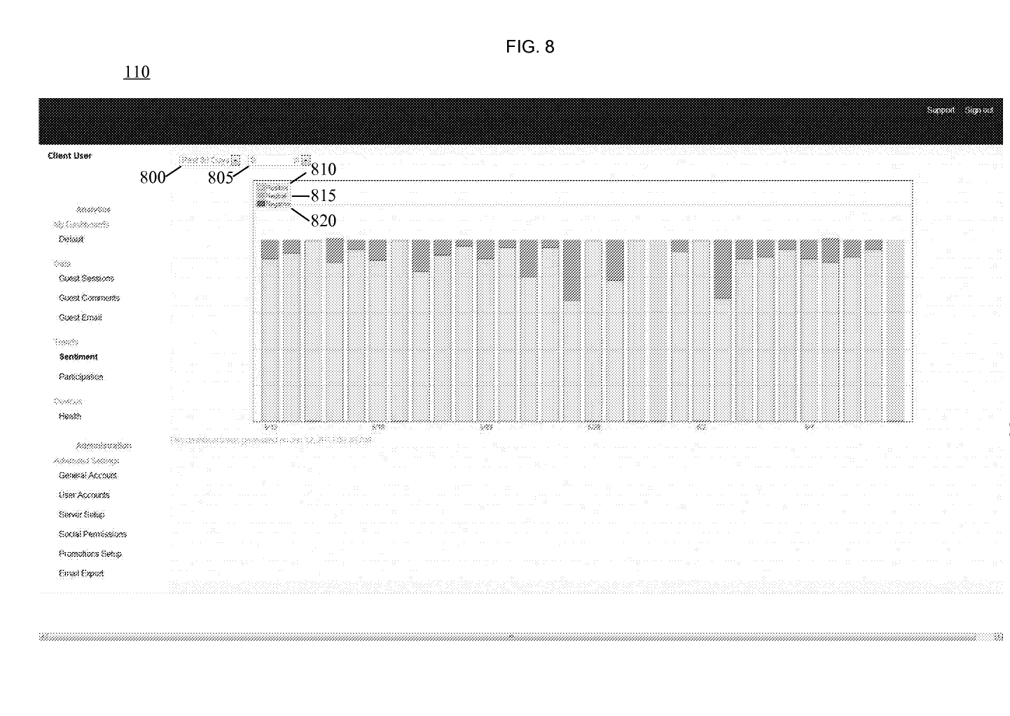

FIG. 8 depicts a screenshot of Sentiment trends in one embodiment of the Client Portal 110. The Client Portal 110 may be configured to display different locations 805, different time periods 800, different devices, etc. of Sentiment Scores received from Guests. In one embodiment, the Client Portal 110 may be configured to display positive feedback 810, neutral feedback 815, and negative feedback 820 in different colors. The Client Portal 110 may display the Sentiment trends with a line graph, a bar graph, or any other display or graph to indicate trends. In other embodiments, the Client Portal 110 may display Sentiment trends with rankings, symbols, numbers, letters, images, etc. By seeing Sentiment trends, the Client User can spot identify what days the feedback is consistently good and try to identify correlations so that the information can be applied to benefit days with worse feedback sentiment trends. In the example of a restaurant, the manager may notice in the Sentiment trends that particular days receive significantly more negative feedback or poor Sentiment scores. Based on this information the manager may look more particularly at the feedback and comments from those days to determine that feedback is consistently negative for the food during a particular chef's shift. The manager can take steps to remedy this situation that would have likely gone unnoticed without the Sentiment trends.

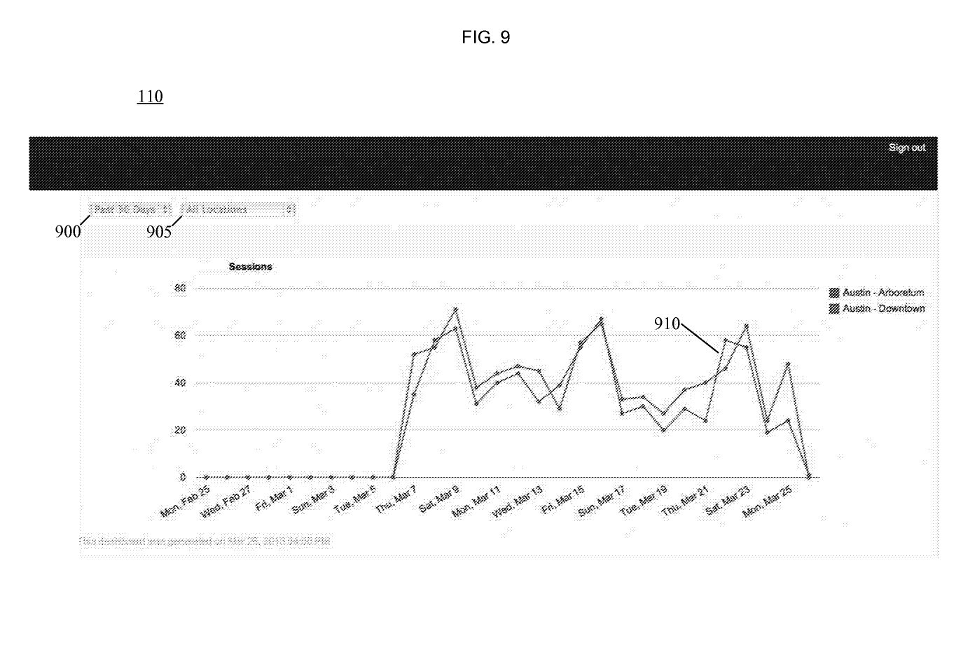

FIG. 9 depicts a screenshot of Participation trends in one embodiment of the Client Portal 110. The Client Portal 110 may be configured to display different locations 905, different time periods 900, different devices, etc. of participation of Guests. The Participation trends will help the Client user to identify ways to increase participation from the Guests. In the example of a restaurant, the manager can identify through the Participation trends 910 that a particular waiter is more successful than the rest at encouraging Guests to leave feedback, and as a result the manager can talk to the waiter of his technique and have the waiter help educate other waiters on how to encourage more Guest participation. In some embodiments, the Client Portal displays multiple locations together, while in other embodiments the Client Portal displays single locations at a time. In one embodiment, the Client Portal 110 may display the Participation trends 910 with a line graph, a bar graph, any other display or graph, etc.

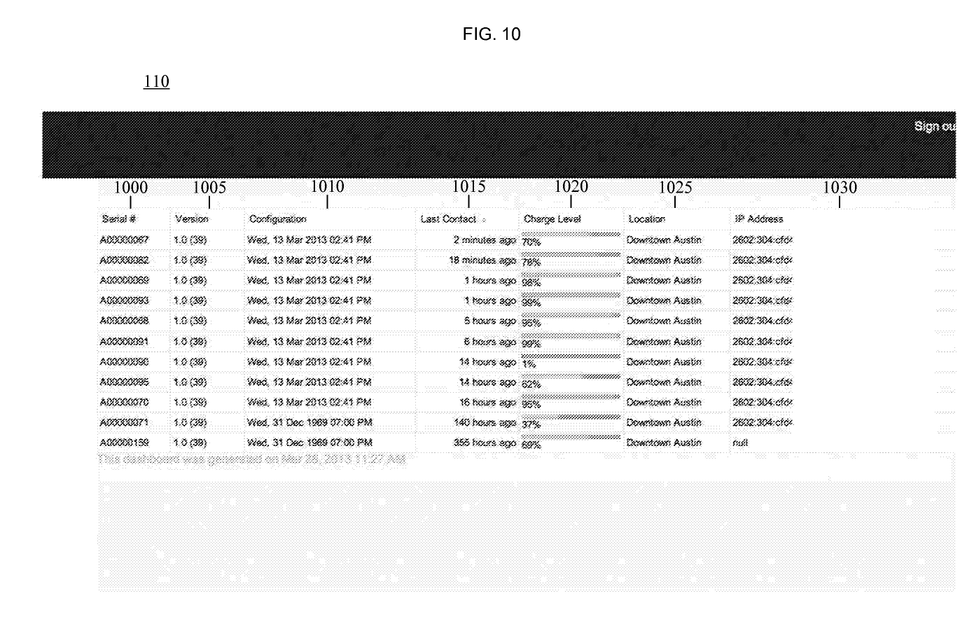

FIG. 10 depicts a screenshot of Device Health in one embodiment of the Client Portal 110 to help the Client User know when a device needs to be charged, updated, maintenance, etc. The Client Portal 110 may display a serial number 1000 for each Device 100. The Client Portal 110 may also display the version 1005, hardware or software, of the Device 100. The Client Portal 110 may display the most recent time and date the Device was configured 1010. The Client Portal 110 may display each configuration made to the Device, the last time the Device was contacted 1015, the charge level of the Device 1020, etc. The Client Portal 110 may display the charge level by percentage, in terms of times, by color, by symbols, etc. The Client Portal 110 may also display the location of the Device 1025. The Client Portal 110 may display the assigned data property, value, person, table, etc. of the Device. The Client Portal 110 may display an IP address associated with each Device 1030.

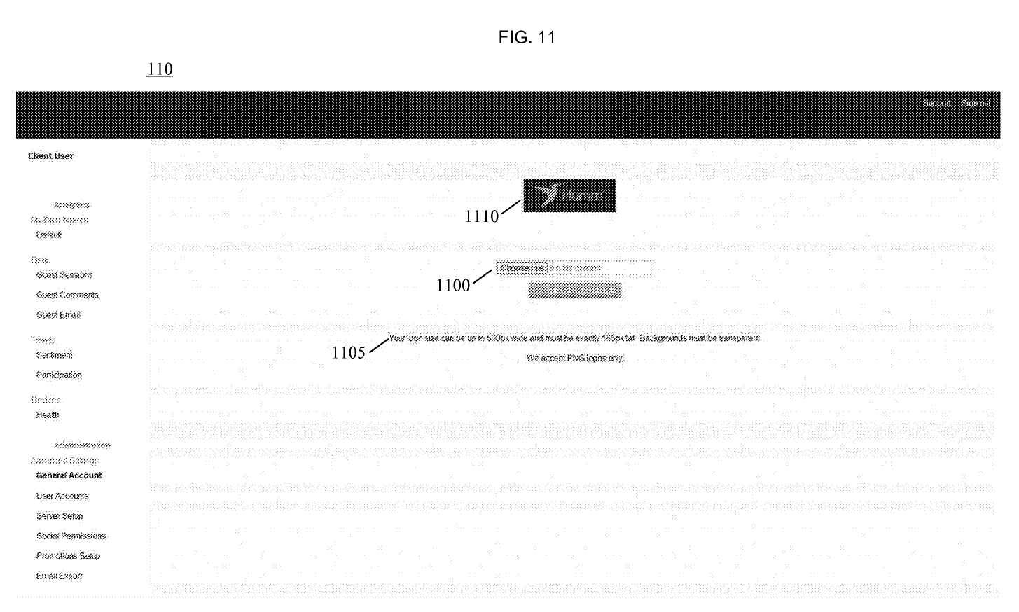

FIG. 11 depicts a screenshot of the General Account Settings in one embodiment of the Client Portal 110. The Client Portal 110 may provide a method 1100 to choose a logo to display on a Device 100. The logo may be an image, video, mixed media, etc. The Client Portal 110 may display the necessary requirements 1105 for the logo to be displayed on the Device. When the logo is received, the Client Portal 110 may display 1110 the logo as it would appear on the Device 100 in the form of a preview for the Client User.

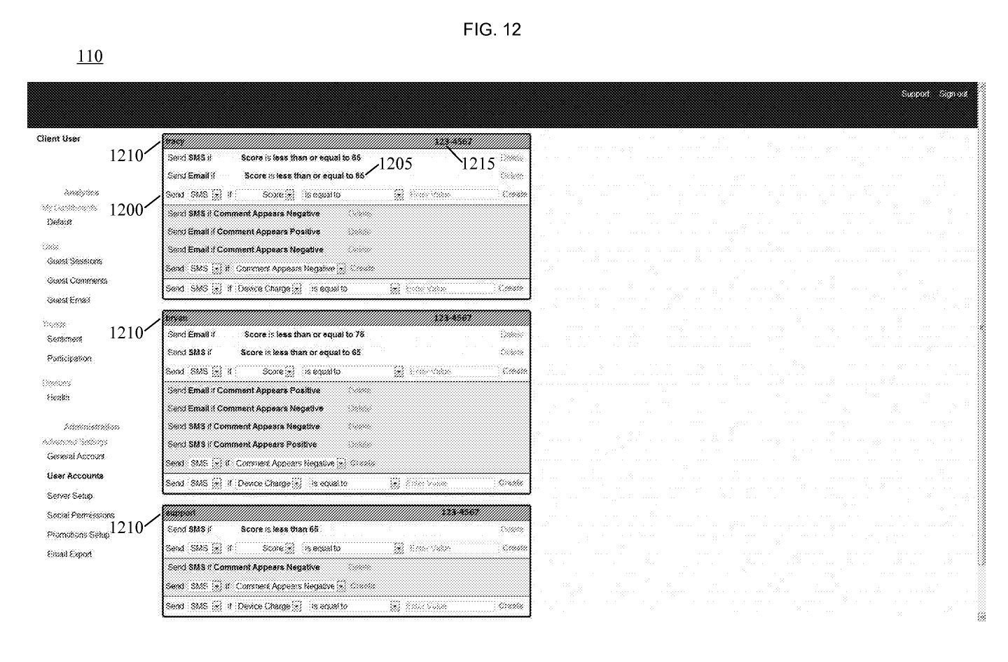

FIG. 12 depicts a screenshot of User Account Settings in one embodiment of the Client Portal 110. In some embodiments, the Client Portal may be used to configure 1200 an alert component within a Device that alerts other subsystems based on configurable feedback events. The Client Portal 110 may display 1205 filters and endpoints to help define the feedback event that is to result in an alert. For example, a Client User can configure the system to send an email if a feedback score of less than 65 is received. In the example of the restaurant, the manager could configure an alert to text the manager if a waiter's score drops below 70, or if a negative comment is received about the food. The subsystems alerted may be any device or method that may receive messages such as SMS, email, social media messaging, third parties, etc. The feedback event may be reaching or passing a threshold for any of the feedback data collected, a particular score, a quantity of particular feedback collected, a positive review, a negative review a comment with a keyword, a request from the Guest, a trend shift, feedback from a predetermined device, feedback from a particular location, etc. The Client Portal 110 may display different Client Users 1210 and each Client User's individual settings. The Client Portal 110 may display a Client User's phone number 1215. The Client Portal 110 may also display a Client User's email address.

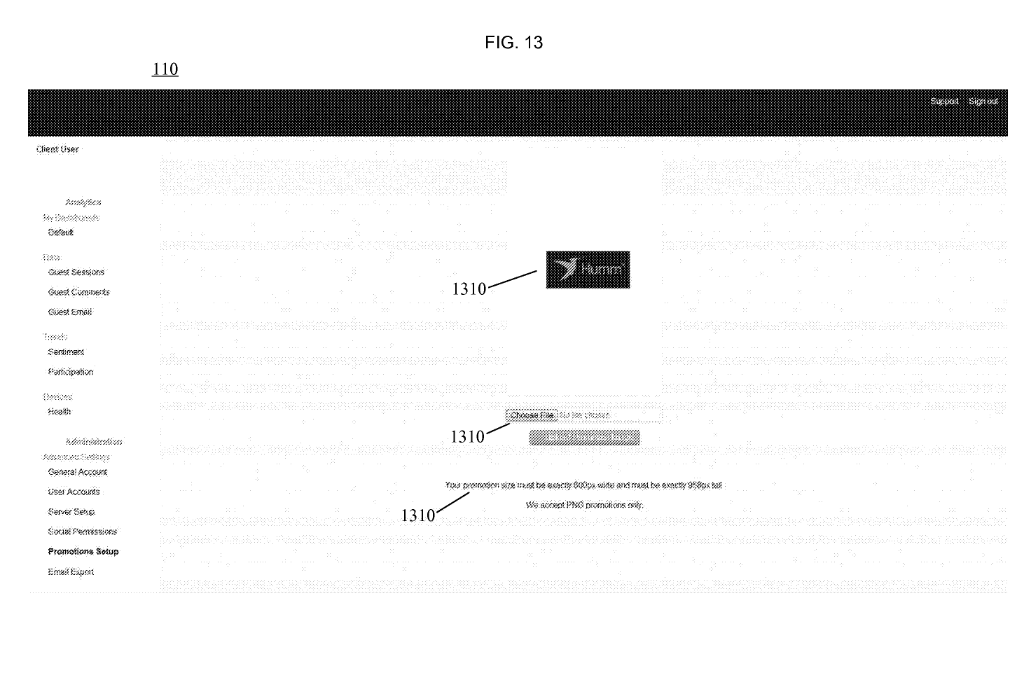

FIG. 13 depicts a screenshot of Promotions Setup Settings in one embodiment of the Client Portal 110. The Client Portal 110 may provide a method 1300 to choose a promotion to display on a Device and/or send to Guest email addresses. The promotion may be an image, video, mixed media, etc. The Client Portal may display the necessary requirements 1305 for the promotion to be displayed on the Device 110. When the promotion is received, the Client Portal may display 1310 the promotion. The promotion may be configured to be displayed on the Device for a set amount of time, for example two weeks, just during happy hour, etc. Multiple promotions can be uploaded to be automatically sent to the device in a predetermined sequence, such as in the case of weekly deals that might change every Tuesday, for example.

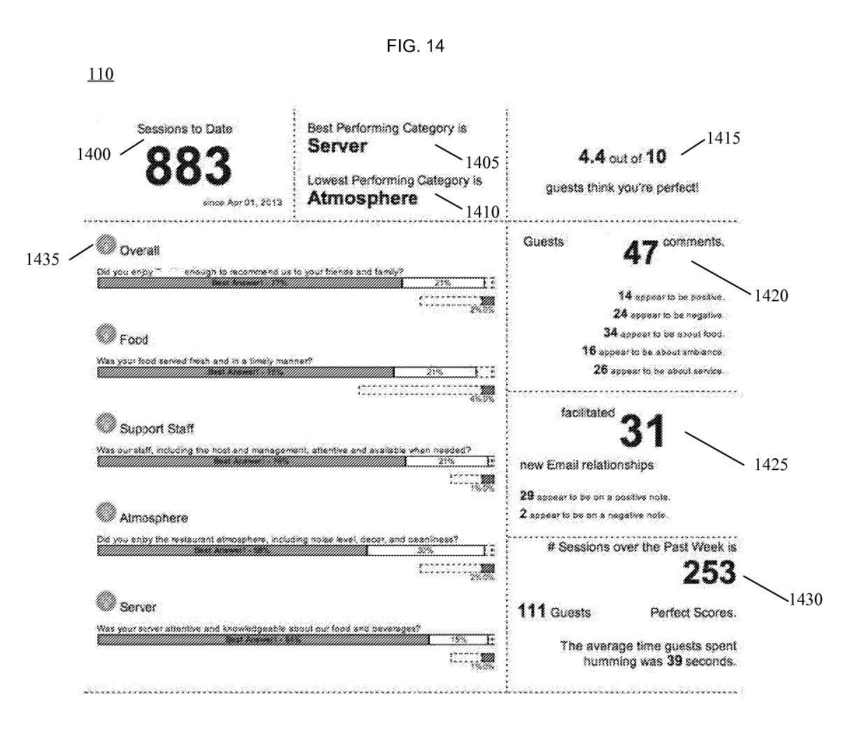

FIG. 14 depicts a screenshot of a Weekly Insights Report in one embodiment of the Client Portal 110. The Client Portal 110 may display a number of Guest Sessions to date 1400, or for a set period of time 1430. The Client Portal 110 may also display a Best Performing Category 1405 and a Lowest Performing Category 1410. The Client Portal 110 may also display a number of perfect scores received by Guests 1415. In another embodiment, the Client Portal 110 may display a number of scores as configured by the Client. In yet another embodiment, the Client Portal 110 may display a ratio of scores configurable by the Client. The Client Portal 110 may also display a number of Guest Comments 1420. The Client Portal 110 may display a number of comments that appear to be positive, negative, or about any category. The Client Portal 110 may also display a number of new email relationships created 1425. The Client Portal 110 may display a number of new email relationships that appear to be on a positive note. The Client Portal 110 may also display a number of new email relationships that appear to be on a negative note. The Client Portal may display ratios of positive answers to negative answers for different categories 1435, and can display the ratios in number form, graph form, etc. In some embodiments, the Weekly Insights Report is configurable by the Client User to show information related to the feedback and analysis that the Client User finds relevant. Some embodiments further include shortcut links configurable by the Client User to allow the Client User quicker access to their preferred data and analysis.

While the disclosed subject matter has been described with respect to a limited number of embodiments, the specific features of one embodiment should not be attributed to other embodiments of the disclosed subject matter. No single embodiment is representative of all aspects of the disclosed subject matter. Moreover, variations and modifications therefrom exist. For example, the disclosed subject matter described herein may comprise other components. Various additives may also be used to further enhance one or more properties. In some embodiments, the disclosed subject matter is substantially free of any additive not specifically enumerated herein. Some embodiments of the disclosed subject matter described herein consist of or consist essentially of the enumerated components. The claims intend to cover all such variations and modifications as falling within the scope of the disclosed subject matter.

What is claimed is:

1. A method comprising:
sending customization data to a digital device located in a consumer setting, wherein the customization data is pre-selected to correspond to the consumer setting;
receiving consumer setting feedback associated with a guest from the digital device, wherein the consumer setting feedback pertains to at least the guest's experience associated with the consumer setting; and
sending results related to the consumer setting feedback toward a client portal, wherein the client portal is private.

2. The method of claim 1, wherein the consumer setting is selected from the group consisting of a restroom, a bar, an event, a concert, an airport, and a combination thereof.

3. The method of claim 1, wherein the customization data is selected from the group consisting of prompts, questions, advertisements, promotions, surveys, themes, and a combination thereof.

4. The method of claim 1, wherein the guest is selected from the group consisting of a non-paying consumer of the consumer setting, a member of the consumer setting, an attendee of the consumer setting, a visitor of the consumer setting, and a combination thereof.

5. The method of claim 1, wherein the client portal is controlled by an authority of the consumer setting selected from the group consisting of a manager of the consumer setting, an owner of the consumer setting, a director of the consumer setting, an officer of the consumer setting, and a combination thereof.

6. The method of claim 1, wherein the results comprise at least a portion of the consumer setting feedback and an analysis based on the consumer setting feedback.

7. The method of claim 6, wherein the analysis comprises assessing feedback trends.

8. The method of claim 6, wherein the analysis comprises assessing a sentiment of the feedback.

9. The method of claim 8, wherein the sentiment of the feedback is selected from the group consisting of positive, negative, neutral, and a combination thereof.

10. The method of claim 1, further comprising storing the consumer setting feedback on a computer readable medium.

11. The method of claim 1, wherein the customization data is configured via the client portal.

12. The method of claim 1, wherein the client portal is accessed via a client computer.

13. The method of claim 1, further comprising receiving alert configurations, wherein said alert configurations configure an alert in response to a predetermined feedback event.

14. The method of claim 1, wherein the client portal is accessed via the Internet.

15. The method of claim 1, wherein the digital device is a portable tablet computer.

16. The method of claim 1, further comprising:
receiving device health information from the digital device; and
sending the device health information to the client portal.

17. A system for collecting feedback comprising:
a digital device;
a client portal;
a server, said server comprising:
a processor;
an interface in communication with said processor; and
a memory in communication with said processor; wherein the following steps are executed on said processor:
sending customization data to a digital device located in a consumer setting, wherein the customization data is pre-selected to correspond to the consumer setting;
receiving consumer setting feedback associated with a guest from the digital device, wherein the consumer setting feedback pertains to at least the guest's experience associated with the consumer setting; and
sending results related to the consumer feedback to a client portal, wherein said client portal is private.

18. The system of claim 17, wherein said digital device is a tablet computer.

19. The system of claim 18, further comprising a check presenter, wherein said check presenter houses said portable digital device.

20. A method comprising:
receiving customization data in a consumer setting, wherein the customization data is pre-selected to correspond to the consumer setting;
receiving consumer setting feedback associated with a guest, wherein the consumer setting feedback pertains to at least the guest's experience associated with the consumer setting; and
sending the consumer setting feedback toward a client portal, wherein the client portal is private.
